(19) United States
(12) Patent Application Publication
(10) Pub. No.: US 2023/0101668 A1
(43) Pub. Date: Mar. 30, 2023

(54) ANTENNA EXCITATION THROUGH LAPTOP HINGE

(71) Applicant: GOOGLE LLC, Mountain View, CA (US)

(72) Inventors: Sung Oh, San Jose, CA (US); Uei-ming Jow, San Diego, CA (US)

(21) Appl. No.: 17/906,328

(22) PCT Filed: Mar. 17, 2020
(86) PCT No.: PCT/US2020/023111

§ 371 Date: Sep. 14, 2022

(51) Int. Cl. H01Q 1/22; H01Q 13/10; H01Q 1/44; G06F 1/16

(52) U.S. Cl. CPC H01Q 1/2266; H01Q 13/10; H01Q 1/44; G06F 1/1698; G06F 1/1681; G06F 1/1683

(57) ABSTRACT

According to an aspect, a computing device includes a first enclosure, a second enclosure, a hinge coupled to the first enclosure and the second enclosure, and a hinge-based antenna defined by a slot of the hinge and a portion of an air gap disposed between the first enclosure and the second enclosure, where the slot of the hinge is aligned with the portion of the air gap, and the hinge-based antenna includes an antenna feed element disposed within the slot of the hinge and configured to excite the portion of the air gap.

### BACKGROUND

Modern laptop designs are trending towards smaller sizes, thereby making the space for an antenna relatively limited.

### SUMMARY

According to an aspect, a computing device includes a first enclosure, a second enclosure, a hinge coupled to the first enclosure and the second enclosure, and a hinge-based antenna defined by a slot of the hinge and a portion of an air gap disposed between the first enclosure and the second enclosure, where the slot of the hinge is aligned with the portion of the air gap, and the hinge-based antenna includes an antenna feed element disposed within the slot of the hinge and configured to excite the portion of the air gap.

According to some aspects, the computing device may include one or more of the following features (or any combination thereof). The hinge includes a first hinge flange, a second hinge flange, and a connector disposed between and connected to the first hinge flange and the second hinge flange, where the connector defines the slot. The hinge-based antenna includes a tuning element disposed within the slot of the hinge. The tuning element may include a capacitor. The hinge-based antenna includes a flexible member that covers the antenna feed element. The hinge is electrically connected to the first enclosure and the second enclosure. The computing device may include a conductive hinge cover (e.g., conductive hinge barrel) disposed over a portion of the hinge, where the conductive hinge cover defines a cavity, and the cavity includes the antenna feed element. The first enclosure may be entirely conductive, and the second enclosure may be entirely conductive.

According to an aspect, a computing device includes a first conductive enclosure, a second conductive enclosure, a first hinge coupled to the first conductive enclosure and the second conductive enclosure, a second hinge coupled to the first conductive enclosure and the second conductive enclosure, and a hinge-based antenna defined by a slot of the first hinge and a portion of an air gap disposed between the first conductive enclosure and the second conductive enclosure. The slot of the hinge is aligned with the portion of the air gap. The hinge-based antenna includes an antenna feed element disposed within the slot of the hinge and configured to excite the portion of the air gap.

According to some aspects, the computing device may include one or more of the above/below features (or any combination thereof). The hinge includes a first hinge flange, a second hinge flange, and a printed circuit board (PCB) connector disposed between and connected to the first hinge flange and the second hinge flange, where the PCB connector defines the slot. The hinge-based antenna includes a tuning element disposed within the slot of the hinge, the tuning element including a capacitor. The capacitor has a first terminal connected to a first inner edge of the hinge and a second terminal connected to a second inner edge of the hinge. The slot defines a first longitudinal axis, and the air gap defines a second longitudinal axis, where the second longitudinal axis is aligned (or substantially aligned) with the first longitudinal axis. The hinge-based antenna includes a flexible member, where the flexible member includes a first portion coupled to the antenna feed element and a second portion coupled to the hinge. The hinge is electrically connected to the first conductive enclosure and the second conductive enclosure. The computing device may include a conductive hinge cover disposed over a portion of the hinge, where the conductive hinge cover defines a cavity, and the cavity includes the antenna feed element. The computing device may be a laptop computer. The computing device is a foldable display device, where the foldable display device includes a foldable display coupled to the first conductive enclosure and the second conductive enclosure.

According to an aspect, a computing device including a first enclosure, a second enclosure, an air gap disposed between the first enclosure and the second enclosure, where the air gap is defined by an edge of the first enclosure and an edge of the second enclosure, a hinge coupled to the first enclosure and the second enclosure, and a hinge-based antenna defined by a slot of the hinge. The slot is aligned with a portion of the air gap. The hinge-based antenna includes an antenna feed element disposed within the slot of the hinge at a first location and configured to excite the portion of the air gap such that the portion of the air gap is used as a radiating structure of the hinge-based antenna. The hinge-based antenna including a tuning element disposed within the slot of the hinge at a second location.

According to some aspects, the computing device may include one or more of the above/below features (or any combination thereof). The hinge includes a first hinge flange, a second hinge flange, and a connector disposed between and connected to the first hinge flange and the second hinge flange. The first hinge flange has a portion that is included within the first enclosure. The second hinge flange has a portion that is included within the second enclosure. The connector has a portion that is defined outside of the first enclosure and the second enclosure. The portion of the connector defines the slot. The slot has a central axis, and the air gap has a central axis, where the central axis of the slot is substantially aligned with the central axis of the air gap. The computing device includes a conductive hinge cover disposed over a portion of the hinge. The hinge is electrically connected to the first enclosure and the second enclosure.

According to an aspect, a method for transmitting a signal using an hinge-based antenna on a computing device, includes receiving a wireless signal via an antenna feed element disposed within a slot of a hinge, and exciting a portion of an air gap formed between two metal enclosures using the wireless signal, where the portion of the air gap is aligned with the slot of the hinge. In some examples, the method includes tuning, by a tuning element disposed within the slot of the hinge, an operating frequency of a radiating structure of the hinge-based antenna defined by the slot and the portion of the air gap.

### BRIEF DESCRIPTION OF THE DRAWINGS

FIG. 1A illustrates a computing device having a hinge-based antenna that uses a portion of an air gap as part of an antenna structure according to an aspect.

FIG. 1B illustrates a portion of the computing device depicting a hinge-based antenna according to an aspect.

FIG. 1C illustrates a detailed view of a hinge including an antenna feed element and a tuning element according to an aspect.

FIG. 2A illustrates an example of a portion of a computing device having a flexible structure disposed over a feeding element and a portion of the hinge according to an aspect.

FIG. 2B illustrates an example of the flexible structure according to an aspect.

FIG. 3A illustrates a computing device having a hinge-based antenna according to aspect.

FIG. 3B illustrates a detailed view of a hinge of the computing device according to an aspect.

FIG. 3C illustrates another perspective of the hinge of the computing device according to an aspect.

FIG. 3D illustrates an example of a connector disposed between hinge flanges according to an aspect.

FIG. 3E illustrates an example of a computing device having a hinge-based antenna according to an aspect.

FIG. 3F illustrates a side view of the computing device depicting the hinge-based antenna according to an aspect.

FIG. 4A illustrates a computing device having a hinge-based antenna with a conductive hinge cover according to an aspect.

FIG. 4B illustrates the computing device having the hinge-based antenna with a conductive hinge cover according to another aspect.

FIG. 4C illustrates a detailed view of the hinge-based antenna with a conductive hinge cover according to an aspect.

FIG. 4D illustrates a detailed view of the hinge-based antenna with a conductive hinge cover according to another aspect.

FIG. 4E illustrates an example of a conductive hinge cover according to an aspect.

FIG. 5 illustrates a graph depicting simulation results of a hinge-based antenna according to an aspect.

FIG. 6 illustrates a graph depicting simulating results of a hinge-based antenna according to another aspect.

FIG. 7A illustrates a foldable display device according to an aspect.

FIG. 7B illustrates the foldable display device with a hinge-based antenna according to an aspect.

FIG. 7C illustrates a detailed view of a hinge of the foldable display device according to an aspect.

FIG. 7D illustrates an example of the hinge-based antenna that uses a portion of an air gap as a radiating structure according to an aspect.

FIG. 7E illustrates an example of the hinge-based antenna that uses a portion of an air gap as a radiating structure according to another aspect.

### DETAILED DESCRIPTION

This disclosure provides a unique antenna concept integrated into a hinge of a computing device (e.g., a laptop, foldable display, or other computing device having movable parts), where the feeding and loading elements (integrated into a hinge) excites the air gap created by a first enclosure (e.g., a laptop display part) and a second enclosure (e.g., a laptop base part). In some examples, the computing device includes a laptop computer having a first enclosure (e.g., a display enclosure that includes a display screen), and a second enclosure (e.g., a base enclosure that includes a keyboard and processors), where the first enclosure is movably coupled to the second enclosure via a hinge that enables the laptop computer to be opened and closed. In some examples, the computing device includes a foldable display device having a first enclosure and a second enclosure, where the first enclosure is movable coupled to the second enclosure via one or more hinges, and a flexible display panel is attached to the first enclosure and the second enclosure. However, the computing device may be any type of computing device that uses a hinge between movable parts.

The computing device includes a hinge-based antenna, where a first portion of the hinge-based antenna is defined by the hinge, and a second portion of the hinge-based antenna is defined by the air gap between the first enclosure and the second enclosure. For example, the hinge may include a slot, and the slot formed by the hinge may be aligned with the air gap formed between the first enclosure and the second enclosure. The combination of the slot formed by the hinge and the air gap provides an extended slot antenna for antenna radiation. In other words, the dimensions of the slot formed by the hinge and the dimensions of the air gap formed between the first enclosure and the second enclosure may define the antenna's frequency (which can be further tuned by a tuning element integrated into the hinge).

The hinge-based antenna includes an antenna feed element (e.g., a transmission line, coaxial cable, a printed circuit board (PCB), a flex PCB, a semi-rigid flex, etc.) disposed at a first location within the slot formed by the hinge. In some examples, the hinge-based antenna includes a tuning element (e.g., an antenna matching element, a loading component, a capacitor, etc.) disposed at a second location within the slot formed by the hinge. In other words, in some examples, the antenna feed element and the tuning element are integrated into the hinge. In some examples, the slot formed by the hinge is a gap (or slit) between hinge flanges. In some examples, the slot of the hinge may be formed by a flex printed circuit board (PCB). In some examples, the slot of the hinge may be an air gap or a non-metal material (e.g., plastic, fr4, polycarbonate, etc.) of the flex PCB. In some examples, the slot of the hinge is used to connect a radio-frequency (RF) signal (e.g., the antenna feed element) and the tuning element (e.g., a capacitor).

In some conventional approaches, the antenna is integrated in the display part, which may require a relatively long cable with thicker display size. Further, in some conventional approaches, the antenna is integrated in the base part (e.g., having the keyboard), which may increase the size of the base part. However, the antenna discussed herein is incorporated partially within the hinge and uses a portion of the air gap between enclosures to function as part of the antenna structure, which may provide a relatively smaller design with increased efficiency (with relatively short cables). Furthermore, in some examples, the antenna structure discussed herein may enable a full metal body laptop, which can increase the durability of the device and/or create a smaller device. In some examples, the computing device includes a conductive (e.g., metal) hinge cover (e.g., barrel) that surrounds (e.g., at least partially surrounds) the hinge.

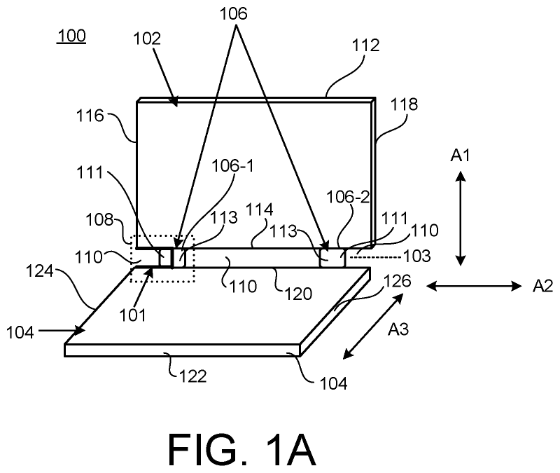

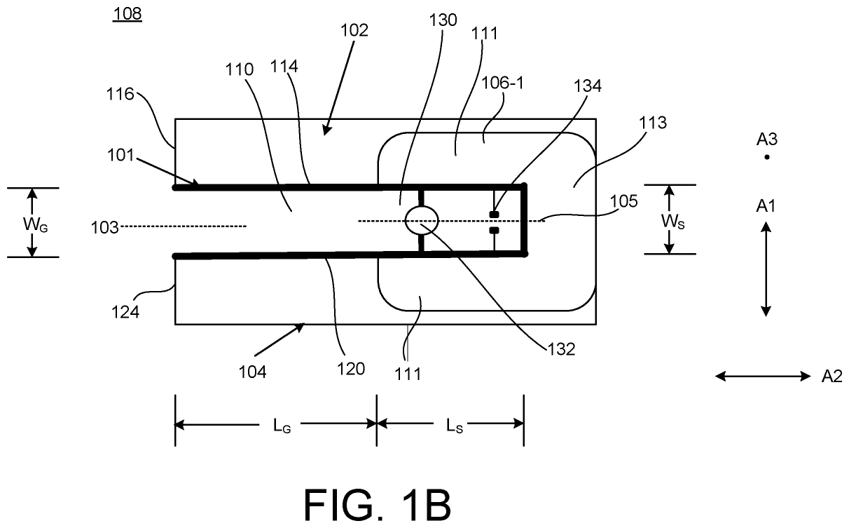

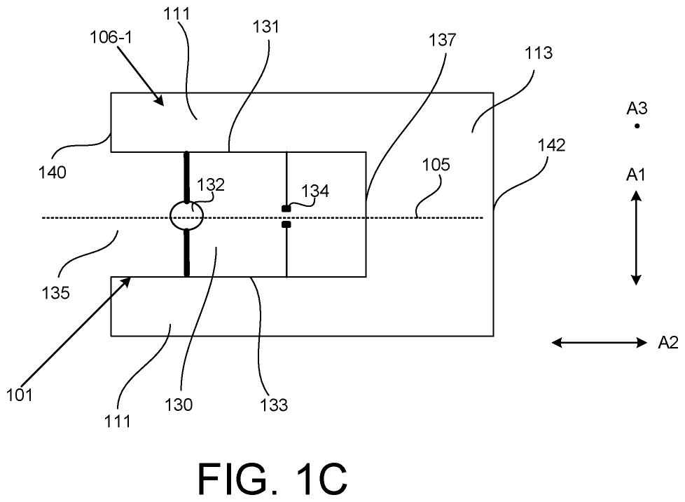

FIGS. 1A through 1C illustrate a computing device 100 having an antenna 101 that is partially integrated into a hinge 106 and extends along an air gap 110 in a direction A2. The antenna 101 may be referred to as a hinge-based antenna. For example, the hinge 106 includes one or more antenna parts such as an antenna feed element 132 and a tuning element 134, where the antenna feed element 132 and the tuning element 134 are disposed within a slot 130 formed by the hinge 106. The air gap 110 (disposed between enclosures) is part of the radiating structure of the antenna 101. For example, the air gap 110 becomes part of the antenna 101 when combined with the hinge 106. In some examples, the antenna feed element 132 and the tuning element 134 are aligned with the air gap 110 to create a radiating structure. The air gap 110 extends along a longitudinal axis 103, and the longitudinal axis 103 is aligned in the direction A2. A direction A1 is aligned perpendicular to the longitudinal axis 103, and the direction A1 is perpendicular to the direction A2. A direction A3 is orthogonal to directions A1 and A2. The directions A1, A2, and A3 are used throughout several of the various views of the implementations described throughout the figures for simplicity.

The computing device 100 includes a first enclosure 102 and a second enclosure 104, where the first enclosure 102 and the second enclosure 104 are connected to each other (and movable with respect to each other) via one or more hinges 106. The hinges 106 couple the first enclosure 102 and the second enclosure 104 together and permits the first enclosure 102 to move (e.g., rotate, translate, etc.) with respect to the second enclosure 104 (or vice versa). Each hinge 106 may include one or more components that permit movement between the first enclosure 102 and the second enclosure 104. In some examples, each hinge 106 may include a first hinge flange and a second hinge flange, and a connector that connects the first hinge flange and the second hinge flange. In some examples, the connector is a printed circuit board (PCB) connector (e.g., a connector constructed from PCB material). As shown in FIG. 1A, the hinges 106 may include a first hinge 106-1 and a second hinge 106-2. Although two hinges 106 are depicted in FIG. 1A, the computing device 100 may include any number of hinges 106 such as one hinge 106 or more than two hinges 106.

FIG. 1A illustrates the computing device 100 in an open position in which the first enclosure 102 is disposed perpendicular to the second enclosure 104. The computing device 100 may be moved to a closed position in which the first enclosure 102 is disposed on top of the second enclosure 104 by rotating the first enclosure 102 towards the second enclosure 104 via the hinges 106. However, it is noted that the hinges 106 may permit the first enclosure 102 to be rotated with respect to the second enclosure 104 (or vice versa) according to any degree of movement including 180-degrees or up to 360-degrees. FIG. 1B illustrates a portion 108 of the computing device 100 depicting the antenna 101 is greater detail according to an aspect. FIG. 1C illustrates the first hinge 106-1 depicting a portion of the antenna 101 in greater detail according to an aspect.

Although FIG. 1A illustrates one antenna 101, in some examples, the computing device 100 may include a number of antennas 101. For example, one antenna 101 may be integrated into the first hinge 106-1 (as shown in FIG. 1A), and another antenna 101 may be integrated into the second hinge 106-2. In some examples, the first hinge 106-1 defines multiple antennas 101. In some examples, the second hinge 106-2 defines multiple antennas 101. For example, as shown in FIG. 1A, the antenna 101 is defined by a first side portion 111 of the first hinge 106-1 and a portion of the air gap 110 that extends from the first hinge 106-1 towards a first lateral side 116 of the first enclosure 102 (and towards a first lateral side 124 of the second enclosure 104) in the direction A2. In some examples, the antenna 101 (or another antenna 101) may be defined by a second side portion 113 of the first hinge 106-1 and a portion of the air gap 110 that extends from the first hinge 106-1 towards the second hinge 106-2 in the direction A2. In some examples, the antenna 101 (or another antenna 101) may be defined by a first side portion 111 of the second hinge 106-2 and a portion of the air gap 110 that extends from the second hinge 106-2 towards a second lateral side 118 of the first enclosure 102 and towards a second lateral side 126 of the second enclosure 104 via the direction A2. In some examples, the antenna 101 (or another antenna) may be defined by a second side portion 113 of the second hinge 106-2 and a portion of the air gap 110 that extends from the second hinge 106-2 towards the first hinge 106-1 in the direction A2.

In some examples, the computing device 100 is a laptop computing device. In some examples, the computing device 100 is a foldable computing device. In some examples, the computing device 100 is a smartphone, tablet, or other computing device having a foldable (e.g., flexible) display panel. However, generally, the computing device 100 may be any type of computing device that has two or more enclosures that are connected via one or more hinges 106. The antenna 101 may send and/or receive wireless signals (e.g., radio frequency signals) such that the computing device 100 may wirelessly communicate with another device. The signals may cause the antenna feed element 132 to excite the portion of the air gap 110 (thereby making the portion of the air gap 110 a part of the antenna's radiating structure). In some examples, the antenna 101 is a Wi-Fi antenna. In some examples, the antenna 101 is a Wi-Fi antenna configured to operate at one or more frequency bands (e.g., at 2.4 GHz, 5.5 GHz). In some examples, the antenna 101 is a short-range antenna (e.g., near-field communication (NFC) antenna, Bluetooth antenna). However, it is noted that the antenna 101 may be turned to operate at any number of frequency bands.

The first enclosure 102 is a housing or casing that includes or attaches one or more components of the computing device 100. The first enclosure 102 includes a first edge 112 and a second edge 114 disposed opposite to the first edge 112. In some examples, the second edge 114 is parallel to the first edge 112. In the orientation of FIG. 1A, the first edge 112 and the second edge 114 extend in the direction A2. In the orientation of FIG. 1A, the distance between the first edge 112 and the second edge 114 extends in the direction A1. The first enclosure 102 includes a first lateral side 116 and a second lateral side 118 disposed opposite to the first lateral side 116. In some examples, the second lateral side 118 is parallel with the first lateral side 116. In the orientation of FIG. 1A, the first lateral side 116 and the second lateral side 118 extend in the direction A1. In the orientation of FIG. 1A, the distance between the first lateral side 116 and the second lateral side 118 extends in the direction A2. In the orientation of FIG. 1, the first enclosure 102 has a thickness that extends in the direction A3. In some examples, the first enclosure 102 is a display enclosure, where the display enclosure includes a display screen (defining the active pixel elements of the display). In some examples, the first enclosure 102 includes a bezel extending around a perimeter area of the first enclosure 102, where the bezel secures the display panel to the first enclosure 102. In some examples, the first enclosure 102 is a conductive-based enclosure (e.g., a conductive or metal enclosure). In some examples, the first enclosure 102 is constructed from one or more conductive materials such as magnesium, alloy, titanium, copper, aluminum, gold, silver, etc. In some examples, the first enclosure 102 is entirely conductive (e.g., entirely metal).

The second enclosure 104 is a housing or casing that includes or attaches one or more components of the computing device 100. The second enclosure 104 includes a first edge 120 and a second edge 122 disposed opposite to the first edge 120. In some examples, the second edge 122 is parallel with the first edge 120. In some examples, the first edge 120 of the second enclosure 104 is parallel with the second edge 114 of the first enclosure 102. In the orientation of FIG. 1A, the first edge 120 and the second edge 122 extend in the direction A2. In the orientation of FIG. 1A, the distance between the first edge 120 and the second edge 122 extends in the direction A3. The second enclosure 104 includes a first lateral side 124 and a second lateral side 126 disposed opposite to the first lateral side 124. In the orientation of FIG. 1A, the first lateral side 124 and the second lateral side 126 extend in the direction A3. In some examples, the second lateral side 126 is parallel with the first lateral side 124. In the orientation of FIG. 1A, the distance between the first lateral side 124 and the second lateral side 126 extends in the direction A2. In the orientation of FIG. 1A, the second enclosure 104 has a thickness that extends in the direction A1. In some examples, the second enclosure 104 is a base enclosure that includes a keyboard and one or more processors (e.g., computer processing units (CPUs), graphic processing units (GPUs), etc.). In some examples, the second enclosure 104 is a conductive-based enclosure. In some examples, the second enclosure 104 is constructed from one or more conductive materials such as magnesium, alloy, titanium, copper, aluminum, gold, silver, etc. In some examples, the second enclosure 104 is entirely conductive (e.g., entirely metal).

The first hinge 106-1 is connected to the first enclosure 102 and the second enclosure 104. In some examples, the first enclosure 102 and the second enclosure 104 are electrically connected with the first hinge 106-1. In some examples, the first hinge 106-1 is connected to the second edge 114 of the first enclosure 102 and connected to the first edge 120 of the second enclosure 104. In some examples, a portion of the first hinge 106-1 is disposed within the first enclosure 102, a portion of the first hinge 106-1 is disposed within the second enclosure 104, and a portion of the first hinge 106-1 is disposed outside of the first enclosure 102 and the second enclosure 104. The antenna 101 may be defined (in part) by the portion of the first hinge 106-1 that is disposed outside of the first enclosure 102 and the second enclosure 104. The second hinge 106-2 is connected to the first enclosure 102 and the second enclosure 104. In some examples, the second hinge 106-2 is connected to the second edge 114 of the first enclosure 102 and connected to the first edge 120 of the second enclosure 104. In some examples, a portion of the second hinge 106-2 is disposed within the first enclosure 102, a portion of the second hinge 106-2 is disposed within the second enclosure 104, and a portion of the second hinge 106-2 is disposed outside of the first enclosure 102 and the second enclosure 104.

The connection of the hinges 106 to the first enclosure 102 and the second enclosure 104 may form the air gap 110 between the first enclosure 102 and the second enclosure 104. For example, the spacing (e.g., empty spacing) between the first enclosure 102 and the second enclosure 104 forms the air gap 110. In some examples, the spacing (e.g., the air gap 110 in the direction A1 and/or A3) is in a range of 0.2 mm to 1 mm. In some examples, the spacing (e.g., the air gap 110 in the direction A1 and/or A3) is in a range of 0.3 mm to 0.8 mm. In some examples, the air gap 110 is the spacing between the second edge 114 of the first enclosure 102 and the first edge 120 of the second enclosure 104 (via direction A1). In the orientation of FIG. 1A, the air gap 110 extends along a longitudinal axis 103 that is aligned with the direction A2. The portion of the first hinge 106-1 and the portion of the second 106-2 (disposed outside of the first enclosure 102 and the second enclosure 104) are disposed within the air gap 110.

Referring to FIG. 1B, the antenna 101 is defined by a slot 130 formed by the first hinge 106-1 and the air gap 110 between the first enclosure 102 and the second enclosure 104, as shown by the bolded line. The geometry of the air gap 110 may determine (or assist with determining) the operating frequency (or frequencies) of the antenna 101. In some examples, the antenna 101 may be a slot antenna having a first portion defined by the slot 130 formed by the first hinge 106-1 and a second portion defined by a portion of the air gap 110 between the first enclosure 102 and the second enclosure 104. For instance, a portion of the air gap 110 is formed as part of the antenna 101, where the portion of the air gap 110 that functions as part of the antenna 101 is defined by the second edge 114 of the first enclosure 102 between the first lateral side 116 and the first hinge 106-1, and the first edge 120 of the second enclosure 104 between the first lateral side 124 and the first hinge 106-1. The portion of the air gap 110 that functions as part of the antenna 101 includes a length (L_{G}) extending in the direction A2, a width (W_{G}) extending in the direction A1, and a thickness extending in the direction A3. The length (L_{G}) may be greater than the width (W_{G}). In some examples, the width (W_{G}) is in a range of 1 mm to 2 mm. In some examples, the width (W_{G}) is in a range of 1.2 mm to 1.8 mm. In some examples, the width (W_{G}) is in a range of 1.4 mm to 1.6 mm. In some examples, the length (L_{G}) is in a range of 15 mm to 100 mm. In some examples, the length (L_{G}) is in a range of 20 mm to 50 mm. In some examples, the length (L_{G}) is in a range of 30 mm to 40 mm.

The first hinge 106-1 may define the slot 130 on the first side portion 111 of the first hinge 106-1. The second side portion 113 of the first hinge 106-1 is the portion that is located in the air gap 110 between the first enclosure 102 and the second enclosure 104. Referring to FIG. 1C, the hinge 106-1 includes a first side 140 and a second side 142. The distance between the first side 140 and the second side 142 may define the width of the first hinge 106-1 (or a portion of the first hinge 106-1). The slot 130 includes an open end 135 (that faces the air gap 110) and a closed end 137 (defined by a portion of the first hinge 106-1), where the distance between the open end 135 and the closed end 137 defines the length (L_{S}) of the slot 130. The open end 135 may be an opening on the first side 140. The closed end 137 may be a portion of the first hinge 106-1 that is positioned in a middle portion of the first hinge 106-1. Also, the slot 130 may be defined by an inner edge 131 of the first hinge 106-1 that extends along the direction A2, and an inner edge 133 of the first hinge 106-1 that extends along the direction A2. In some examples, the inner edge 131 of the first hinge 106-1 is aligned with the second edge 114 of the first enclosure 102. In some examples, the inner edge 133 of the first hinge 106-1 is aligned with the first edge 120 of the second enclosure 104.

The slot 130 may be a slit or gap. In some examples, the slot 130 is an air gap. In some examples, the slot 130 is formed by removing a portion of the first hinge 106-1. In some examples, the first hinge 106-1 includes a PCB material, and a portion of the PCB material is removed to form the slot 130. In some examples, the slot 130 is a non-conductive material (e.g., plastic or polymer-based material, fr4, polycarbonate, etc.). In some examples, the slot 130 is a non-conductive material of the PCB material. The slot 130 includes a length (L_{S}) extending in the direction A2, and a width (W_{S}) extending in the direction A1. In some examples, the slot 130 includes a thickness extending in the direction A3. In some examples, the length (L_{S}) of the slot 130 is less than the length (L_{G}) of the portion of the air gap 110. In some examples, the width (W_{S}) of the slot 130 is greater than the width (W_{G}) of the air gap 110. In some examples, the width (W_{S}) of the slot 130 is substantially the same as the width (W_{G}) of the air gap 110.

The slot 130 is aligned with the air gap 110. In some examples, the combination of the space of the slot 130 and the space of the air gap 110 forms a continuous slot antenna (e.g., integral slot antenna) having a length of L_{G}+L_{S}. The slot 130 defines a longitudinal axis 105 along the direction A2. In some examples, the longitudinal axis 105 of the slot 130 is aligned with the longitudinal axis 103 of the air gap 110. In some examples, the longitudinal axis 105 of the slot 130 is a central axis (that divides the slot 130 into equal halves), and the longitudinal axis 103 of the air gap 110 is a central axis (that divides the air gap 110 into equal halves), where the central axis of the slot 130 is aligned or substantially aligned with the central axis of the air gap 110. In some examples, the longitudinal axis 105 of the slot 130 is located at the same position along the direction A1 as the longitudinal axis 103 of the air gap 110 or the difference between the positions along the direction A1 is equal to or below a threshold amount (e.g., 0.2 mm, 0.4 mm, or 0.6 mm) (e.g., a difference equal to or below the threshold amount indicates that the central axis of the air gap 110 is substantially aligned with the central axis of the slot 130).

The antenna 101 includes an antenna feed element 132 and a tuning element 134. The antenna feed element 132 and the tuning element 134 are integrated into the first hinge 106-1. The antenna feed element 132 and/or the tuning element 134 are configured to excite the air gap 110 created by the first enclosure 102 and the second enclosure 104. The antenna feed element 132 is disposed within the slot 130 of the first hinge 106-1. The antenna feed element 132 may extend across the slot 130 in the direction A1. In some examples, the antenna feed element 132 is connected to the inner edge 131 and connected to the inner edge 133. In some examples, the antenna feed element 132 includes a transmission line. In some examples, the antenna feed element 132 includes a coaxial cable, a PCB, a flex PCB, or a semi-rigid flex. The tuning element 134 is disposed within the slot 130. The tuning element 134 may extend across the slot 130. In some examples, the tuning element 134 is connected to the inner edge 131 and connected to the inner edge 133. In some examples, the tuning element 134 includes an antenna matching element. In some examples, the tuning element 134 includes a capacitor having a first terminal connected to the inner edge 131 and a second terminal connected to the inner edge 133.

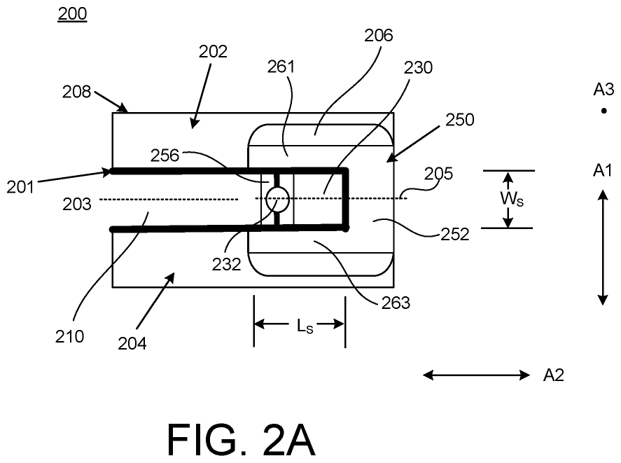

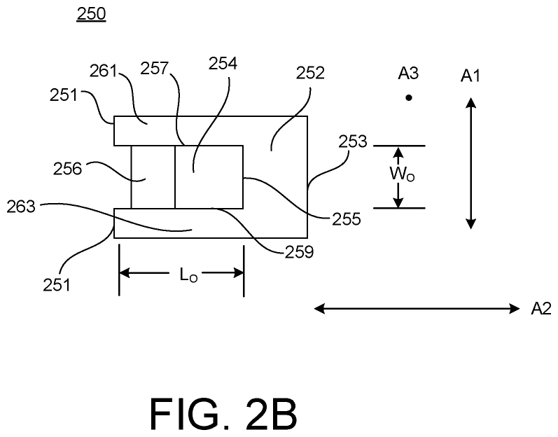

FIG. 2A illustrates a portion 208 of a computing device 200 depicting an antenna 201 incorporated into a hinge 206 that uses an air gap 210 as part of the radiating structure of the antenna 201 according to an aspect. As shown in FIG. 2A, the antenna 201 includes a flexible member 250 for an antenna feed element 232 that is disposed within a slot 230 of the hinge 206. In some examples, the flexible member is a flexible PCB. FIG. 2A illustrates an example of the flexible member 250 according to an aspect. The computing device 200 may be an example of the computing device 100 of FIG. 1A, and may include any of the features described with reference to the previous figures.

The hinge 206 is connected to a first enclosure 202 and a second enclosure 204, where the space between the first enclosure 202 and the second enclosure 204 defines the air gap 210. The air gap 210 has a longitudinal axis 203 that extends along the direction A2. The hinge 206 defines a slot 230 that is aligned with the air gap 210. For example, the slot 230 includes a longitudinal axis 205. In some examples, the longitudinal axis 205 of the slot 230 is aligned with the longitudinal axis 203 of the air gap 210. As shown in FIG. 2A, the slot 230 includes a width (W_{S}) in the direction A1 and a length (L_{S}) in the direction A2.

As shown in FIG. 2A, the antenna 201 includes a flexible member 250 for the antenna feed element 232. For example, the antenna feed element 232 is disposed within the slot 230, and the flexible member 250 is coupled to or disposed over the antenna feed element 232. Referring to FIGS. 2A and 2B, the flexible member 250 includes a portion 261 that is coupled to a portion of the hinge 206 disposed within the first enclosure 202 and a portion 263 that is coupled to a portion of the hinge 206 disposed within the second enclosure 204.

The flexible member 250 includes a portion 256 that is coupled to (or encloses) the antenna feed element 232 (and extends across the slot 230 in the direction A1). The flexible member 250 includes a portion 252 that extends between the first enclosure 202 and the second enclosure 204. Referring to FIG. 2B, the flexible member 250 includes a first side 251 and a second side 253. The flexible member 250 defines an opening 254 that extends from the first side 251 to an interior edge 255. The portion 252 may be defined as the area between the second side 253 and the interior edge 255. The opening 254 has a length (Lo) extending in the direction A2, and a width (Wo) extending in the direction A1. For example, the length (Lo) may be defined as the distance between the first side 251 and the interior edge 255. The width (Wo) may be defined as the distance between an inner edge 257 and an inner edge 259. The portion 256 may be disposed within the opening 254 and extend from the inner edge 257 to the inner edge 259. In some examples, the length (Lo) is substantially the same as the length (L_{S}) of the slot 230. In some examples, the width (Wo) is substantially the same as the width (W_{S}) of the slot 230.

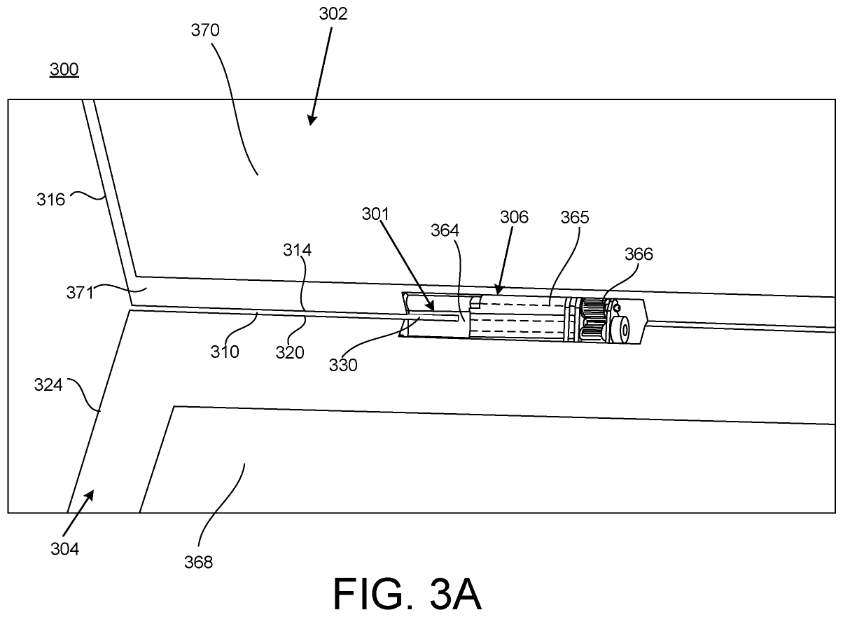

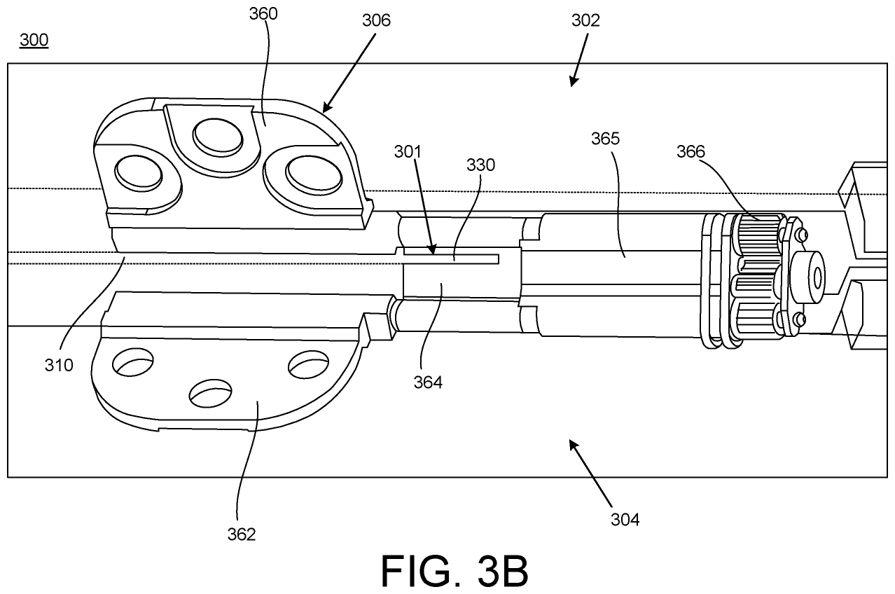

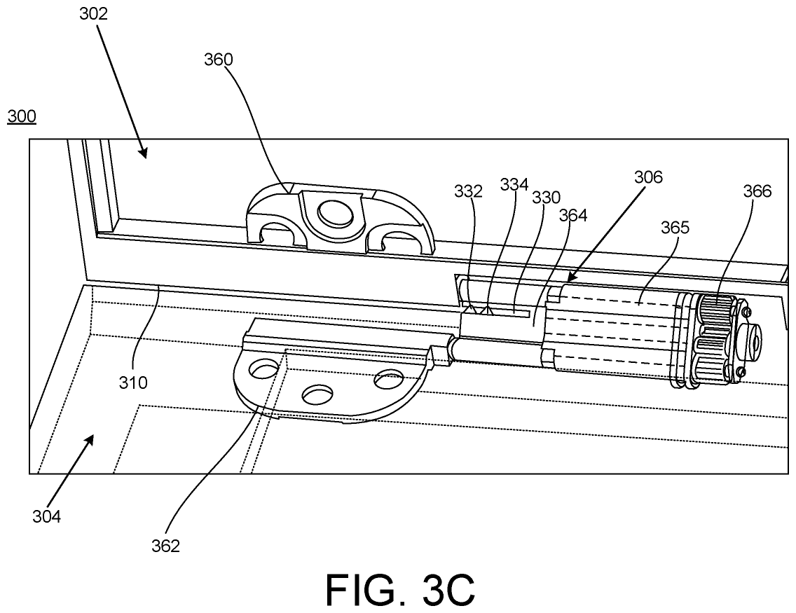

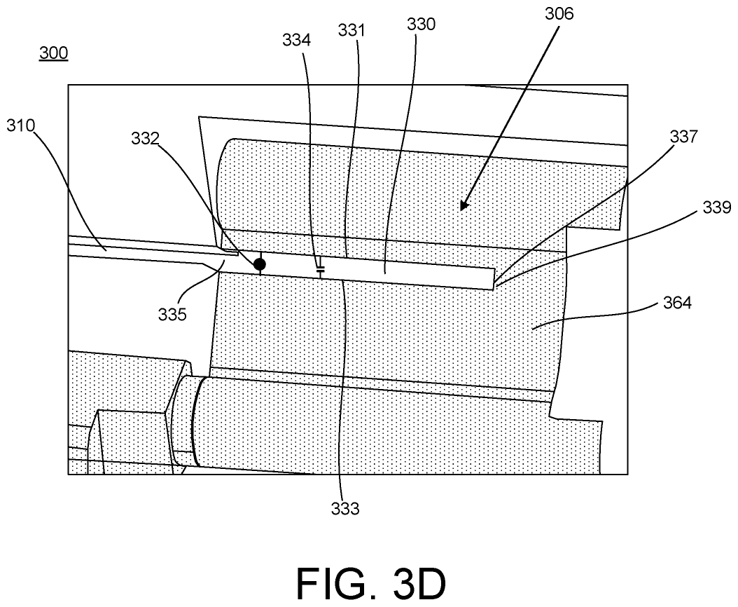

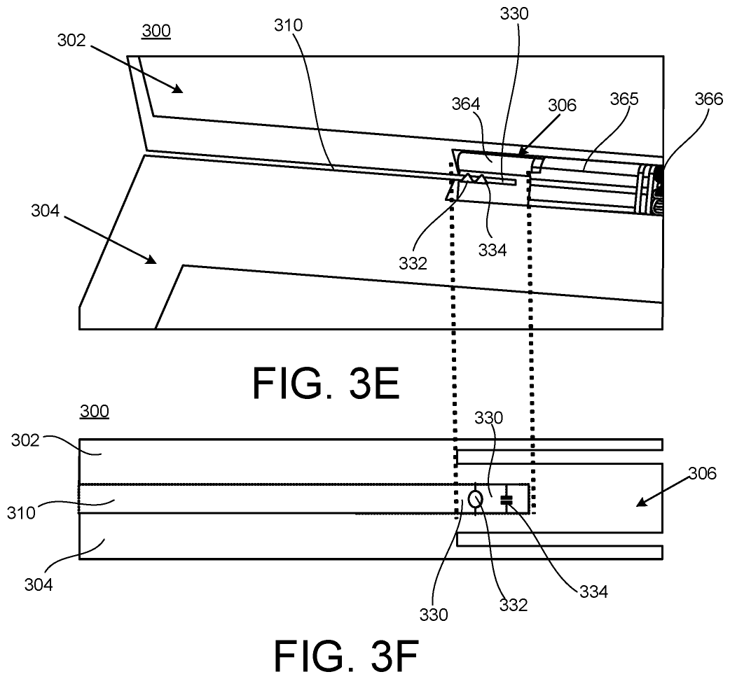

FIGS. 3A through 3F illustrate a computing device 300 depicting an antenna 301 incorporated into a hinge 306 that uses an air gap 310 as part of the radiating structure of the antenna 301 according to an aspect. FIG. 3A illustrates a perspective of the computing device 300 depicting the hinge 306 having a slot 330 that is used as part of the antenna 301. FIG. 3B illustrates a detailed view of the hinge 306 defining the slot 330 that is aligned with an air gap 310. FIG. 3C illustrates another detailed view of the hinge 306 with an integrated antenna 301. FIG. 3D illustrates a detailed view of a PCB connector 364 of the hinge 306 that defines the slot 330. FIGS. 3E and 3F illustrate perspectives of the computing device 300 with the antenna 301 integrated into the hinge 306. The computing device 300 may be an example of the computing device 100 of FIGS. 1A through 1C and/or the computing device 200 of FIGS. 2A through 2B, and may include any of the details discussed with reference to those figures.

The computing device 300 includes an antenna 301 that is partially integrated into the hinge 306 and extends along an air gap 310. For example, the hinge 306 includes one or more antenna parts such as an antenna feed element 332 and a tuning element 334, where the antenna feed element 332 and the tuning element 334 are disposed within a slot 330 of the hinge 306. Also, the air gap 310 (disposed between enclosures) is part of the radiating structure of the antenna 301. For example, the air gap 310 becomes part of the antenna 301 when combined with the hinge 306. In some examples, the antenna feed element 332 and the tuning element 334 are aligned with the air gap 310 to create a radiating structure that is defined by the slot 330 and the air gap 310.

The antenna 301 may send and/or receive wireless signals (e.g., radio frequency signals) such that the computing device 300 may wirelessly communicate with another device. In some examples, the antenna 301 is a Wi-Fi antenna. In some examples, the antenna 301 is a Wi-Fi antenna configured to operate at one or more frequency bands (e.g., at 2.4 GHz, 5.5 GHz). In some examples, the antenna 301 is a short-range antenna (e.g., near-field communication (NFC) antenna, Bluetooth antenna). However, it is noted that the antenna 101 may be turned to operate at any number of frequency bands.

The computing device 300 is a laptop computing device. The computing device 300 includes a first enclosure 302 and a second enclosure 304. The first enclosure 302 is a housing or casing that includes or attaches one or more components of the computing device 300. The first enclosure 302 includes a display screen 370 and a bezel area 371. In some examples, the first enclosure 302 is a conductive-based enclosure. In some examples, the first enclosure 302 is constructed from one or more conductive materials such as magnesium, alloy, titanium, copper, aluminum, gold, silver, etc. In some examples, the first enclosure 302 is entirely conductive (e.g., entirely metal). The second enclosure 304 is a housing or casing that includes or attaches one or more components of the computing device 300. The second enclosure 304 includes a keyboard 368 and one or more processors (e.g., computer processing units (CPUs), graphic processing units (GPUs), etc.) disposed within the second enclosure 304. In some examples, the second enclosure 304 is a conductive-based enclosure. In some examples, the second enclosure 304 is constructed from one or more conductive materials such as magnesium, alloy, titanium, copper, aluminum, gold, silver, etc. In some examples, the second enclosure 304 is entirely conductive (e.g., entirely metal).

The first enclosure 302 and the second enclosure 304 are connected to each other (and movable with respect to each other) via one or more hinges 306. The hinges 306 couple the first enclosure 302 and the second enclosure 304 together and permit the first enclosure 302 to move (e.g., rotate, translate, etc.) with respect to the second enclosure 304 (or vice versa).

The hinge 306 includes a first hinge flange 360 and a second hinge flange 362, and a PCB connector 364 that connects the first hinge flange 360 and the second hinge flange 362. In some examples, at least a portion of the first hinge flange 360 is disposed within and connected to the first enclosure 302. In some examples, at least a portion of the second hinge flange 362 is disposed within and connected to the second enclosure 304. The PCB connector 364 is connected to the first hinge flange 360 and the second hinge flange 362. The PCB connector 364 may extend across the air gap 310 between the first enclosure 302 and the second enclosure 304. In some examples, the PCB connector 364 is constructed from a PCB material.

The hinge 306 may include barrel members 365 (e.g., cylindrical barrels) and gear members 366. In some examples, the barrel members 365 are parts of (or extensions of) the first hinge flange 360 and the second hinge flange 362. In some examples, the gear members 366 are parts of (or extensions of) the first hinge flange 360 and the second hinge flange 362. The gear members 366 may couple the first hinge flange 360 and the second hinge flange 362 together (and/or couple the barrel members 365 together) and permit the first hinge flange 360 to rotate with respect to the second hinge flange 362 (or vice versa). The first hinge flange 360, the second hinge flange 362, the PCB connector 364, the barrel members 365, and the gear members 366 may be operably connected to (or extend from) each in order to permit the first enclosure 302 to move with respect to the second enclosure 304 (or vice versa).

The connection of the hinge 306 to the first enclosure 302 and the second enclosure 304 forms the air gap 310 between the first enclosure 302 and the second enclosure 304. For example, the spacing (e.g., empty spacing) between the first enclosure 302 and the second enclosure 304 forms the air gap 310. In some examples, the width of the air gap 310 is in a range of 1 mm to 2 mm. In some examples, the width of the air gap 310 is in a range of 1.2 mm to 1.8 mm. In some examples, the width of the air gap 310 is defined by the distance between an edge 314 of the first enclosure 302 and an edge 320 of the second enclosure 304.

The antenna 301 includes a slot 330 formed by the PCB connector 364 of the hinge 306. The slot 330 may be a slit or gap in the PCB connector 364. The slot 330 includes an open end 335 directly exposed to the air gap 310 (or directly adjacent to the air gap 310), and a closed end 337 defined by an interior portion 339 of the PCB connector 364. The distance between the open end 335 and the closed end 337 may define the length of the slot 330 formed on the PCB connector 364. The width of the slot 330 may be defined by a first interior edge 331 and a second interior edge 333. In some examples, the second interior edge 333 is positioned in parallel with the first interior edge 331. In some examples, the slot 330 is an air gap. In some examples, the slot 330 is formed by removing a portion of the PCB material from the PCB connector 364. In some examples, the slot 330 is a non-conductive material of the PCB connector 364. In some examples, the length of the slot 330 is less than the length of the portion of the air gap 310 that functions as part of the antenna 301. In some examples, the width of the slot 330 is greater than the width of the air gap 310. In some examples, the width of the slot 330 is substantially the same as the width of the air gap 310.

The slot 330 is aligned with the air gap 310. The combination of the space provided by the slot 330 and the space provided by the portion of the air gap 310 defines the radiating structure of the antenna 301. In other words, the antenna 301 is defined by the slot 330 of the PCB connector 364 and a portion of the air gap 310. For instance, a portion of the air gap 310 is formed as part of the antenna 301, where the portion of the air gap 310 that functions as part of the antenna 301 is defined by i) the edge 314 of the first enclosure 302 between a lateral side 316 of the first enclosure 302 and the PCB connector 364, and ii) the edge 320 of the second enclosure 304 between a lateral side 324 and the PCB connector 364. The portion of the air gap 310 that functions as part of the antenna 301 includes a length in a range of 15 mm to 100 mm, a range of 20 mm to 50 mm, or a range of 30 mm to 40 mm. The portion of the air gap 310 that functions as part of the antenna 301 includes a width in a range of 1 mm to 2 mm, a range of 1.2 mm to 1.8 mm, or a range of 1.4 mm to 1.6 mm.

The antenna 301 includes an antenna feed element 332 and a tuning element 334. The antenna feed element 332 and the tuning element 334 are integrated into the hinge 306. The antenna feed element 332 and/or the tuning element 334 are configured to excite the air gap 310 created by the first enclosure 302 and the second enclosure 304. The antenna feed element 332 is disposed within the slot 330 of the PCB connector 364. The antenna feed element 332 may extend across the slot 330. In some examples, the antenna feed element 332 is connected to the first interior edge 331 and the second interior edge 333. In some examples, the antenna feed element 332 includes a transmission line, a coaxial cable, a PCB, a flex PCB, and/or a semi-rigid flex. The tuning element 334 is disposed within the slot 330. The tuning element 334 may extend across the slot 330. In some examples, the tuning element 334 is connected to the first interior edge 331 and connected to the second interior edge 333. In some examples, the tuning element 334 includes an antenna matching element. In some examples, the tuning element 334 includes a capacitor having a first terminal connected to the first interior edge 331 and a second terminal connected to the second interior edge 333.

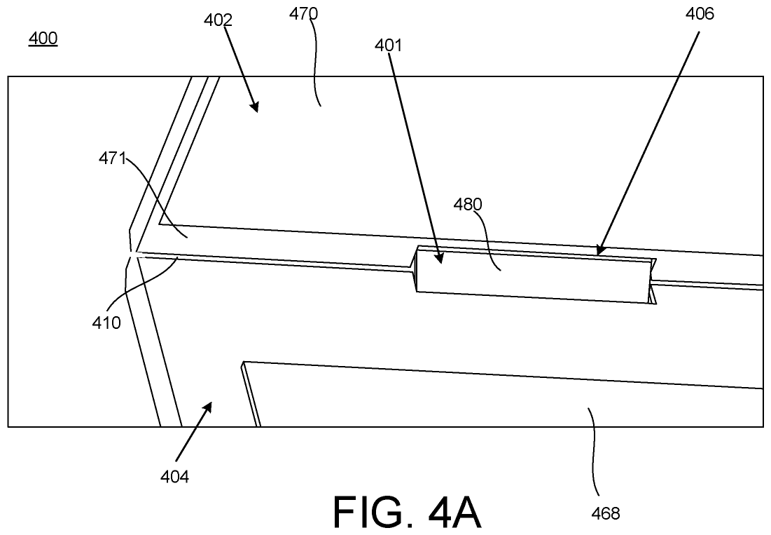

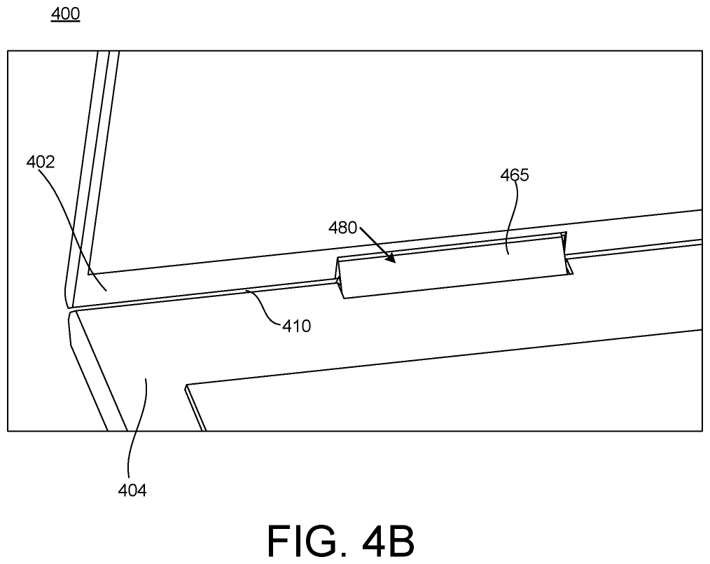

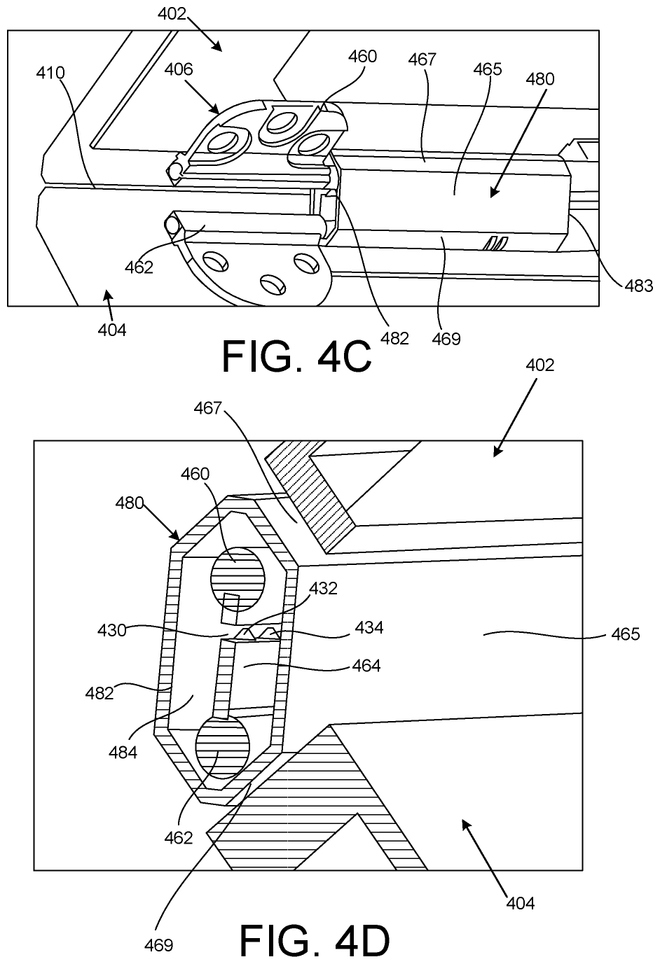

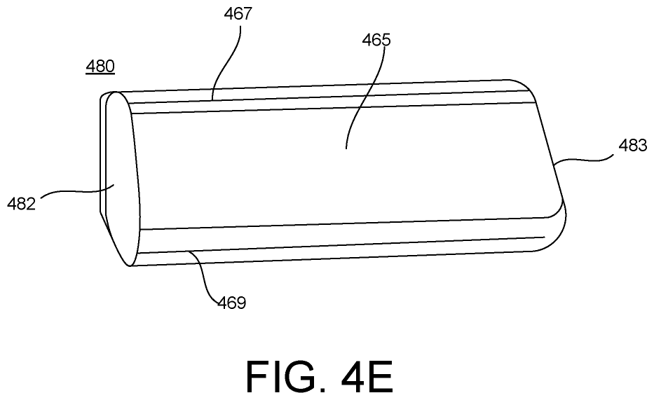

FIGS. 4A through 4E illustrate a computing device 400 depicting an antenna 401 incorporated into a hinge 406 and a conductive hinge cover 480 disposed over the hinge 406 according to an aspect. Similar to the other embodiments, the antenna 401 uses an air gap 410 as part of the radiating structure of the antenna 401 according to an aspect. The computing device 400 may be an example of the computing device 100 of FIGS. 1A through 1C, the computing device 200 of FIGS. 2A through 2B, and/or the computing device 300 of FIGS. 3A through 3F, and may include any of the features explained with reference to those figures. In some examples, the computing device 400 is a laptop computer.

The computing device 400 includes a first enclosure 402 having a display screen 470 and a bezel area 471. The computing device 400 includes a second enclosure 404 having a keyboard 468. In some examples, the first enclosure 402 is entirely metal, and the second enclosure 404 is entirely metal. The first enclosure 402 is connected to the second enclosure 404 via one or more hinges 406. In some examples, the hinge 406 is electrically connected to the first enclosure 402 and the second enclosure 404. The hinge 406 includes the antenna 401 and uses a portion of the air gap 410 as the radiating structure of the antenna 401. In some examples, the hinge 406 may be the same as the hinge 306 of FIGS. 3A through 3F. For example, the hinge 406 includes a first hinge flange 460, a second hinge flange 462, and a PCB connector 464 that extends between and connects the first hinge flange 460 and the second hinge flange 462.

The antenna 401 is defined by a slot 430 formed by the PCB connector 464 and a portion of the air gap 410 between the first enclosure 402 and the second enclosure 404. The slot 430 is aligned with the air gap 410. The antenna 401 includes an antenna feed element 432 disposed within the slot 430 at a first location, and a tuning element 434 disposed within the slot 430 at a second location. The antenna feed element 432 and the tuning element 434 are aligned with the air gap 410. The tuning element 434 is configured to tune the operating frequency of the antenna 401. The antenna feed element 432 is configured to excite the slot antenna defined by the slot 430 and the portion of the air gap 410.

The conductive hinge cover 480 is coupled to the hinge 406. In some examples, the conductive hinge cover 480 is a conductive hinge cap or a conductive hinge barrel. The conductive hinge cover 480 is configured to surround the hinge 406 with the integrated antenna feed element 432 and the tuning element 434. The conductive hinge cover 480 defines a cavity 484, and the first hinge flange 460, the second hinge flange 462, and the PCB connector 464 are disposed within the cavity 484 of the conductive hinge cover 480. In some examples, the conductive hinge cover 480 is entirely conductive (e.g., metal). In some examples, the conductive hinge cover 480, the first enclosure 402, and the second enclosure 404 are entirely conductive (e.g., metal), thereby enabling a full metal casing laptop.

The conductive hinge cover 480 includes a first side portion 482 and a second side portion 483. The distance between the first side portion 482 and the second side portion 483 may define the length of the conductive hinge cover 480. In some examples, the first side portion 482 defines an opening that exposes the slot 430. In some examples, the first side portion 482 does not define an opening but defines a closed metallic end. The conductive hinge cover 480 includes a front portion 465, an upper portion 467, and a lower portion 469. In some examples, the distance between the upper portion 467 and the lower portion 469 may define the height (or width) of the conductive hinge cover 480. In some examples, the upper portion 467 is curved. In some examples, the lower portion 469 is curved. In some examples, the upper portion 467 is disposed at a non-zero angle with respect to the front portion 465. In some examples, the lower portion 469 is disposed at a non-zero angle with respect to the front portion 465. In some examples, the design of the antenna 401 enables the placement of one or more antennas 401 inside relatively smaller hinge covers, which can enable a full-metal body laptop design. Also, the conductive hinge cover 480 may be relatively small as compared to some conventional designs which typically are plastic and larger.

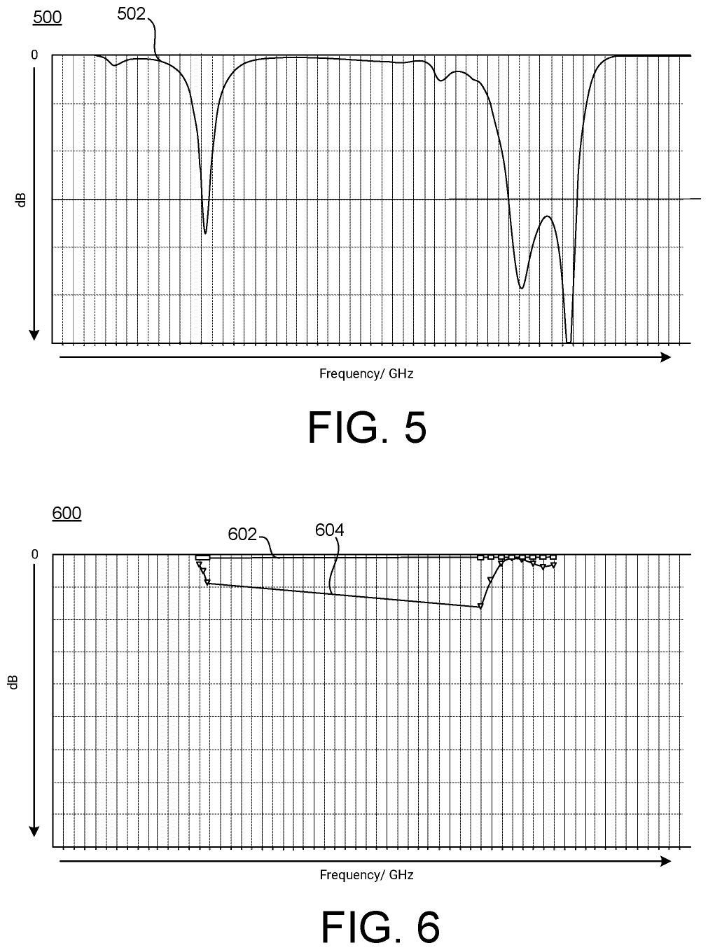

FIG. 5 illustrates a graph 500 depicting simulation results in terms of return loss versus frequency according to an aspect. For example, the graph 500 includes a line 502 that shows the return loss in terms of magnitude decibels (dB) over increasing frequency values. FIG. 6 illustrates a graph 600 depicting simulation results in terms of efficiency versus frequency according to an aspect. For example, the graph 600 includes a line 602 that shows the radiation efficiency in terms of magnitude dB over increasing frequency values, and a line 604 that shows the total efficiency in terms of magnitude dB over increasing frequency values. The simulation results of FIGS. 5 through 6 may be applicable to any of the disclosed embodiments. In some examples, the simulation results of FIGS. 5 through 6 relate to a computing device having the antenna design discussed herein along with fully metal enclosures and a fully metal hinge cover. As shown in the graph 500 and the graph 600, the hinge-based antenna is relatively efficient because the hinge can excite the air gap effectively (even though it may be surrounded by a metal hinge cover).

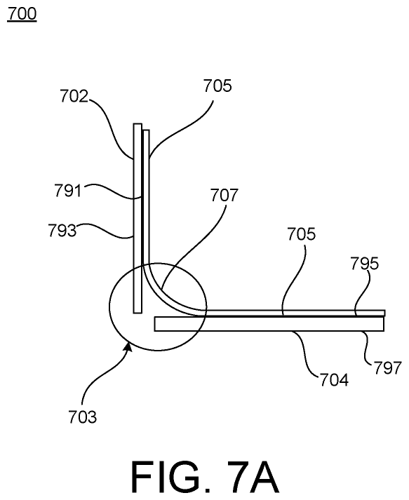

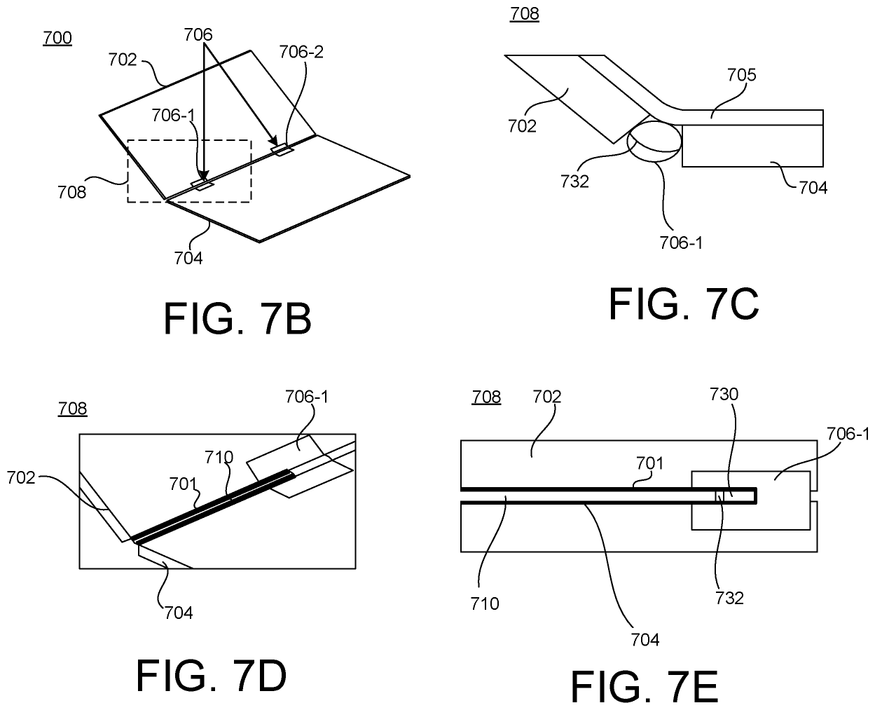

FIGS. 7A through 7E illustrate a computing device 700 having an antenna 701 incorporated into a hinge 706, which uses an air gap 710 as part of the radiating structure of the antenna 701 according to an aspect. The computing device 700 is a foldable display device. In some examples, the computing device 700 is a metal laptop computer (e.g., full metal casing laptop). In some examples, the computing device 700 is a foldable smartphone or tablet with one or more metal enclosures. The computing device 700 may be an example of the computing device 100 of FIGS. 1A through 1C, the computing device 200 of FIGS. 2A through 2B, the computing device 300 of FIGS. 3A through 3F, and/or the computing device 400 of FIGS. 4A through 4E, and may include any of the features discussed with reference to those figures.

FIG. 7A illustrates a perspective of the computing device 700 that depicts a location 703 of the antenna 701. FIG. 7B illustrates another perspective of the computing device 700 having multiple hinges 706. Although two hinges 706 are depicted in FIG. 7B, the computing device 700 may include any number of hinges 706 such as one hinge 706 or more than two hinges 706. FIG. 7C illustrates a portion 708 of the computing device 700 that depicts a first hinge 706-1 in greater detail. FIG. 7D illustrates a detailed view of the antenna 701 of the computing device 700. FIG. 7E illustrates another perspective of the antenna 701 of the computing device 700.

The computing device 700 includes a first enclosure 702, a second enclosure 704, and one or more hinges 706 connected to the first enclosure 702 and the second enclosure 704 in order to permit the first enclosure 702 and the second enclosure 704 to rotate with respect to each other. The first enclosure 702 is a housing or casing that includes or attaches one or more components of the computing device 700. In some examples, the first enclosure 702 is a conductive-based enclosure. In some examples, the first enclosure 702 is constructed from one or more conductive materials such as magnesium, alloy, titanium, copper, aluminum, gold, silver, etc. In some examples, the first enclosure 702 is entirely conductive (e.g., entirely metal). The second enclosure 704 is a housing or casing that includes or attaches one or more components of the computing device 700. In some examples, the second enclosure 704 is a conductive-based enclosure. In some examples, the second enclosure 704 is constructed from one or more conductive materials such as magnesium, alloy, titanium, copper, aluminum, gold, silver, etc. In some examples, the second enclosure 704 is entirely conductive (e.g., entirely metal). In some examples, the first enclosure 702 is separate and distinct from the second enclosure 704.

The first enclosure 702 includes a first surface 791 and a second surface 793. The second enclosure 704 includes a first surface 795 and a second surface 797. The computing device 700 includes a foldable display 705 that is coupled to the first enclosure 702 and the second enclosure 704. In some examples, the foldable display 705 is a display panel having one or more portions that are flexible or bendable. The foldable display 705 may define the display screen (e.g., the active pixel area). In some examples, the display screen is the entire surface of the foldable display 705. The foldable display 705 is coupled to the first surface 791 of the first enclosure 702 and coupled to the first surface 795 of the second enclosure 704. The foldable display 705 includes a portion 707 that is configured to fold (e.g., bend) when the first enclosure 702 is moved with respect to the second enclosure 704 (or vice versa).

As shown in FIG. 7B, the hinges 706 may include a first hinge 706-1 and a second hinge 706-2. The first hinge 706-1 and the second hinge 706-2 are connected to the first enclosure 702 and the second enclosure 704. The first hinge 706-1 may incorporate the antenna 701. However, it is noted that the second hinge 706-2 may also include an antenna 701. The antenna 701 includes a slot 730 formed by the first hinge 706-1. The antenna 701 includes an antenna feed element 732 disposed within the slot 730. In some examples, although not shown in FIGS. 7A through 7E, the antenna 701 may include a tuning element (e.g., a capacitor) positioned in the slot 730. As shown in FIGS. 7D and 7E, the air gap 710 is aligned with the slot 730 (and the antenna feed element 732), thereby causing a portion of the air gap 710 to become part of the structure of the antenna 701. By using the hinge-based antenna structure that uses a portion of the air gap 710 as the radiating structure, the thickness of foldable devices (and the size of the bezel area) may be reduced. Furthermore, the length of antenna cables that are typically used to connect an antenna to the processors in the body of one or more enclosures may be reduced.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims. Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “receiving”, or “processing” or “computing” or “calculating” or “determining” or “displaying” or “providing”, or “partitioning”, or “constructing”, or “selecting”, or “comparing” or the like, refer to the action and processes of a computer system, or similar electronic computing device, that manipulates and transforms data represented as physical (electronic) quantities within the computer system memories or registers or other such information storage, transmission or display devices.

It will be appreciated that the above embodiments that have been described in particular detail are merely examples or possible embodiments, and that there are many other combinations, additions, or alternatives that may be included.

What is claimed is:

1. A computing device comprising:
a first enclosure;
a second enclosure;
a hinge coupled to the first enclosure and the second enclosure; and
a hinge-based antenna defined by a slot of the hinge and a portion of an air gap disposed between the first enclosure and the second enclosure, the slot of the hinge being aligned with the portion of the air gap, the hinge-based antenna including an antenna feed element disposed within the slot of the hinge and configured to excite the portion of the air gap.

2. The computing device of claim 1, wherein the hinge includes a first hinge flange, a second hinge flange, and a connector disposed between and connected to the first hinge flange and the second hinge flange, the connector defining the slot.

3. The computing device of claim 1, wherein the hinge-based antenna includes a tuning element disposed within the slot of the hinge.

4. The computing device of claim 3, wherein the tuning element includes a capacitor.

5. The computing device of claim 1, wherein the hinge-based antenna includes a flexible member that covers the antenna feed element.

6. The computing device of claim 1, wherein the hinge is electrically connected to the first enclosure and the second enclosure.

7. The computing device of claim 1, further comprising:
a conductive hinge cover disposed over a portion of the hinge, the conductive hinge cover defining a cavity, the cavity including the antenna feed element.

8. The computing device of claim 1, wherein the first enclosure is entirely conductive, and the second enclosure is entirely conductive.

9. A computing device comprising:
a first conductive enclosure;
a second conductive enclosure;
a first hinge coupled to the first conductive enclosure and the second conductive enclosure;
a second hinge coupled to the first conductive enclosure and the second conductive enclosure; and
a hinge-based antenna defined by a slot of the first hinge and a portion of an air gap disposed between the first conductive enclosure and the second conductive enclosure, the slot of the hinge being aligned with the portion of the air gap, the hinge-based antenna including an antenna feed element disposed within the slot of the hinge and configured to excite the portion of the air gap.

10. The computing device of claim 9, wherein the hinge includes a first hinge flange, a second hinge flange, and a printed circuit board (PCB) connector disposed between and connected to the first hinge flange and the second hinge flange, the PCB connector defining the slot.

11. The computing device of claim 9, wherein the hinge-based antenna includes a tuning element disposed within the slot of the hinge, the tuning element including a capacitor, the capacitor having a first terminal connected to a first inner edge of the hinge and a second terminal connected to a second inner edge of the hinge.

12. The computing device of claim 9, wherein the slot defines a first longitudinal axis, and the air gap defines a second longitudinal axis, the second longitudinal axis being aligned with the first longitudinal axis.

13. The computing device of claim 9, wherein the hinge-based antenna includes a flexible member, the flexible member including a first portion coupled to the antenna feed element, the flexible member including a second portion coupled to the hinge.

14. The computing device of claim 9, wherein the hinge is electrically connected to the first conductive enclosure and the second conductive enclosure, further comprising.
a conductive hinge cover disposed over a portion of the hinge, the conductive hinge cover defining a cavity, the cavity including the antenna feed element.

15. The computing device of claim 9, wherein the computing device is a laptop computer.

16. The computing device of claim 9, wherein the computing device is a foldable display device, the foldable display device including a foldable display coupled to the first conductive enclosure and the second conductive enclosure.

17. A computing device comprising:
a first enclosure;
a second enclosure;
an air gap disposed between the first enclosure and the second enclosure, the air gap being defined by an edge of the first enclosure and an edge of the second enclosure;
a hinge coupled to the first enclosure and the second enclosure; and
a hinge-based antenna defined by a slot of the hinge, the slot being aligned with a portion of the air gap, the hinge-based antenna including an antenna feed element disposed within the slot of the hinge at a first location and configured to excite the portion of the air gap such that the portion of the air gap is used as a radiating structure of the hinge-based antenna, the hinge-based antenna including a tuning element disposed within the slot of the hinge at a second location.

18. The computing device of claim 17, wherein the hinge includes a first hinge flange, a second hinge flange, and a connector disposed between and connected to the first hinge flange and the second hinge flange, the first hinge flange having a portion that is included within the first enclosure, the second hinge flange having a portion that is included within the second enclosure, the connector having a portion that is defined outside of the first enclosure and the second enclosure, the portion of the connector defining the slot, the slot having a central axis, the air gap having a central axis, the central axis of the slot being substantially aligned with the central axis of the air gap.

19. The computing device of claim 1, further comprising:
a conductive hinge cover disposed over a portion of the hinge.

20. The computing device of claim 1, wherein the hinge is electrically connected to the first enclosure and the second enclosure.
